(19) United States
(12) Patent Application Publication
(10) Pub. No.: US 2008/0056843 A1
(43) Pub. Date: Mar. 6, 2008

(54) Rotary release pin

(75) Inventors: James C. Klingenberg, Concord, OH (US); David Craig Hageman, Chagrin Falls, OH (US)

Correspondence Address: FAY SHARPE LLP, 1100 SUPERIOR AVENUE, SEVENTH FLOOR, CLEVELAND, OH, 44114, US

(73) Assignee: Jergens, Inc.

(21) Appl. No.: 11/897,663

(22) Filed: Aug. 31, 2007

Related U.S. Application Data
(60) Provisional application No. 60/841,623, filed on Aug. 31, 2006.

(51) Int. Cl. F16B 21/00

(52) U.S. Cl. 411/347

(57) ABSTRACT

A quick release pin has an elongated body having an axial bore therethrough and a shaft extending at least partially through the axial bore for rotational movement within the bore. A button is mounted on a first end of the shaft. At least one opening is formed in a second end of the shaft. A handle has a central passage through which the button extends. The handle is mounted to the elongated body. The button has a resilient member for engaging and disengaging an opening in the handle for locking and unlocking the pin. The knob can have a member which engages and slides along a groove formed in a surface of the handle.

### CLAIM OF PRIORITY

This application claims priority from Provisional Application Serial No. 60/841,623 filed on Aug. 31, 2006.

### BACKGROUND OF THE INVENTION

The invention of this application relates to release pins and, more particularly, to rotary release pins.

Releasable securing devices, such as ball pins, are commonly used for joining two parts such as the parts of industrial fixtures together. Such ball pins have a hollow, hardened stem insertable through mating bores in the two parts to be joined. The device further includes an abutment surface on one side of the stem configured to be pressed against the one side of the stacked parts. The other side of the device includes depressible or retractable balls near the tip of the pin which are configured to engage the other side of the parts when they are in the extended position.

Quick connect ball locking devices generally include a plurality of detents, such as balls, trapped within a tube but protruding out openings therein. A ball actuator is reciprocal within the tube and movable from a first position wherein the balls are retracted substantially within the tube or moved outwardly a sufficient distance to lock the balls within a mating receptacle. An example of such a ball locking device is shown in U.S. Pat. No. 5,394,594 which is incorporated by reference herein. U.S. Pat. No. 3,277,767 also shows such a releasable securing device and is also incorporated by reference herein for showing the same.

More particularly, and with reference to FIG. 1, a prior art release pin RP is shown having a handle H, a knob K and a shank SH. Pin RP further includes a spindle SP that is configured to actuate balls B1 and B2. Pin RP further includes a compression spring CS that is mounted within an enlarged bore EB between knob K and shank SH to urge knob K and spindle SP in axial direction A1. A knob shoulder KS on the knob engages abutment AB on handle H to limit this movement. In the position shown, pin RP is in the locked condition wherein land L of spindle SP holds balls B1 and B2 in a projected position. Knob K, extending from the shank, may be moved manually in axial direction A2 to bring a groove G into registry with the balls and thereby permit radially inward movement of the balls to along ramp R to a release or unlocked condition. Spindle SP of pin RP further includes a spindle shaft SS that extends through a shank bore SB in Shank SH to interengage with knob K. Accordingly, the prior art device's spindle extends from its working end by land L to knob K.

Thus, the prior art pins are biased in a locked position. The user has to depress the knob, thus compressing the spring and moving the shaft in an axial direction A2 to allow the balls to move to a released or unlocked position. There is no indication on the existing release pins that the pin is in either a locked or unlocked position. Furthermore, the existing release pin requires axial movement of the shaft and button to actuate or release the balls. The user must continue to push on the button or knob to maintain the pin in an unlocked position. Thus, there is a need for a release pin with a knob which only needs to be rotated, can be locked into an unlock or lock position, and which indicates that the pin is in a locked or unlocked position.

### SUMMARY OF THE INVENTION

The invention of this application relates to fastener devices and is particularly directed to quick release pin assemblies which have a knob rotatable between a locked and unlocked position. The release pin according to one aspect of the present invention includes a central shaft and an actuating knob or button attached thereto. The knob is rotated from a locked position to an unlocked position. A coiled spring is used to bias the knob to the locked position. When the knob is rotated 90 degrees, the central shaft also rotates within a longitudinal bore in the shank of a pin to translate the motion of the button. Rotation of the shaft acts to cause radial movement of balls outward beyond the outer surface of the pin shank to form a projecting abutment. One or more recessed portions on the movable shaft can be used to hold the balls in a recessed or unlocked position to permit the balls to be moved radially inwardly so that they do not project beyond the outer surface of the shank.

The release pin of the present invention has a handle attached to the shank. The shaft is mounted within the bore of the shank and has the button mounted at one end of the shaft.

In one embodiment, a spring can be mounted between the button and the handle which biases the knob or button to a locked position.

In another embodiment, the knob has a locking pin which is biased within a locked recessed opening in the upper surface of the handle. The locking pin is manually pulled or moved out of engagement with the “lock” recessed opening and is flexed radially inwardly. The knob is rotated about 90 degrees to the “unlock” recessed opening in the handle. The pin is released, and the spring bias of the pin moves the pin into the “unlock” opening.

In another embodiment, a quick release pin has an elongated body having an axial bore therethrough; a shaft extending at least partially through the axial bore for rotational movement within the bore; a button mounted on a first end of the shaft; at least one opening formed in a second end of the shaft; a handle having a central passage through which the button extends, wherein the handle is mounted to the elongated body; and wherein the button has a resilient member for engaging and disengaging an opening in the handle for locking and unlocking the pin.

In yet another embodiment, a release pin has an elongated body having an axial bore therethrough; a shaft extending through the bore for rotational movement; a knob mounted to a first end of the shaft; at least one slot formed in a second end of the shaft; a handle mounted to the elongated body, the handle having a central passage therethrough; a biasing member interposed between the knob and the handle within the central passage for biasing the knob in a locked position; wherein the knob comprises a member which engages and slides along a groove formed in a surface of the handle.

Other aspects of the present invention will become apparent to those of average skill in the art upon a reading and understanding of the following detailed description.

### BRIEF DESCRIPTION OF THE DRAWINGS

FIG. 1 is a side elevational view in cross-section of an existing release pin;

FIG. 2A is a top plan view of the handle of a rotary release pin in a locked position in accordance with an embodiment of the present invention;

FIG. 2B is a perspective view of the pin of FIG. 2A;

FIG. 2C is a side elevational view of the pin of FIG. 2B;

FIG. 2D is a cross-sectional view through lines 2D-2D of FIG. 2C;

FIG. 3A is a top plan view of a handle of a rotary release pin in a locked position in accordance with a second embodiment of the present invention;

FIG. 3B is a perspective view of the pin of FIG. 3A;

FIG. 3C is a side elevational view of the pin of FIG. 3B;

FIG. 3D is a cross-sectional view through lines 3D-3D of FIG. 3C;

FIG. 4A is a top plan view of a handle of a rotary release pin in a locked position in accordance with a third embodiment of the present invention;

FIG. 4B is a perspective view of the pin of FIG. 4A;

FIG. 4C is a side elevational view of the pin of FIG. 4B;

FIG. 4D is a cross-sectional view through lines 4D-4D of FIG. 4C;

FIG. 5A is a top plan view of a handle of a rotary release pin in a locked position in accordance with a fourth embodiment of the present invention;

FIG. 5B is a perspective view of the pin of FIG. 5A;

FIG. 5C is a side elevational view of the pin of FIG. 5B;

FIG. 5D is a cross-sectional view through lines 5D-5D of FIG. 5C;

FIG. 6A is a top plan view of a handle of a rotary release pin in a locked position in accordance with a fifth embodiment of the present invention;

FIG. 6B is a perspective view of the pin of FIG. 6A;

FIG. 6C is a side elevational view of the pin of FIG. 6B;

FIG. 6D is a cross-sectional view through lines 6D-6D of FIG. 6C;

FIG. 7A is a top plan view of a handle of a rotary release pin in a locked position in accordance with a sixth embodiment of the present invention;

FIG. 7B is a perspective view of the pin of FIG. 7A;

FIG. 7C is a side elevational view of the pin of FIG. 7B;

FIG. 7D is a cross-sectional view through lines 7D-7D of FIG. 7C;

FIG. 8A is a perspective view of a pin in accordance with a seventh embodiment of the present invention; and

FIG. 8B is a cross-sectional view through lines 8B-8B of FIG. 8A.

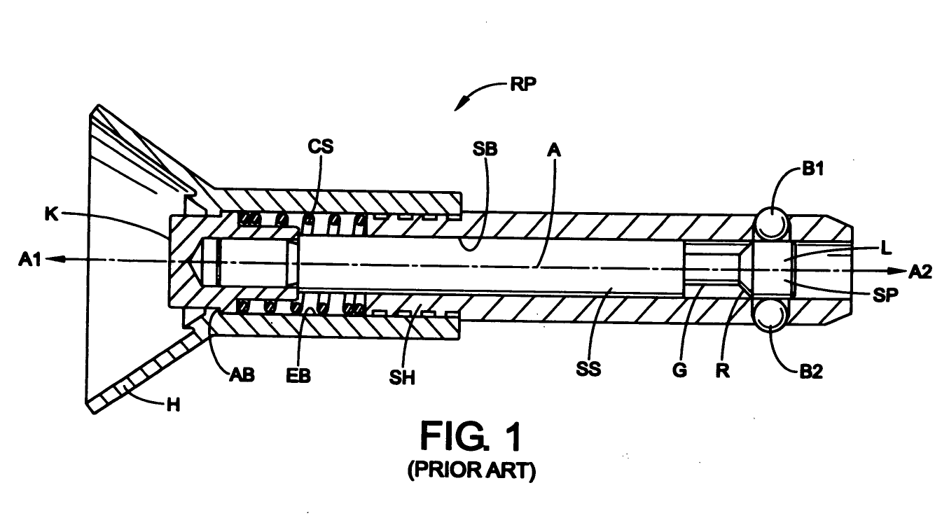

### DETAILED DESCRIPTION OF EMBODIMENTS

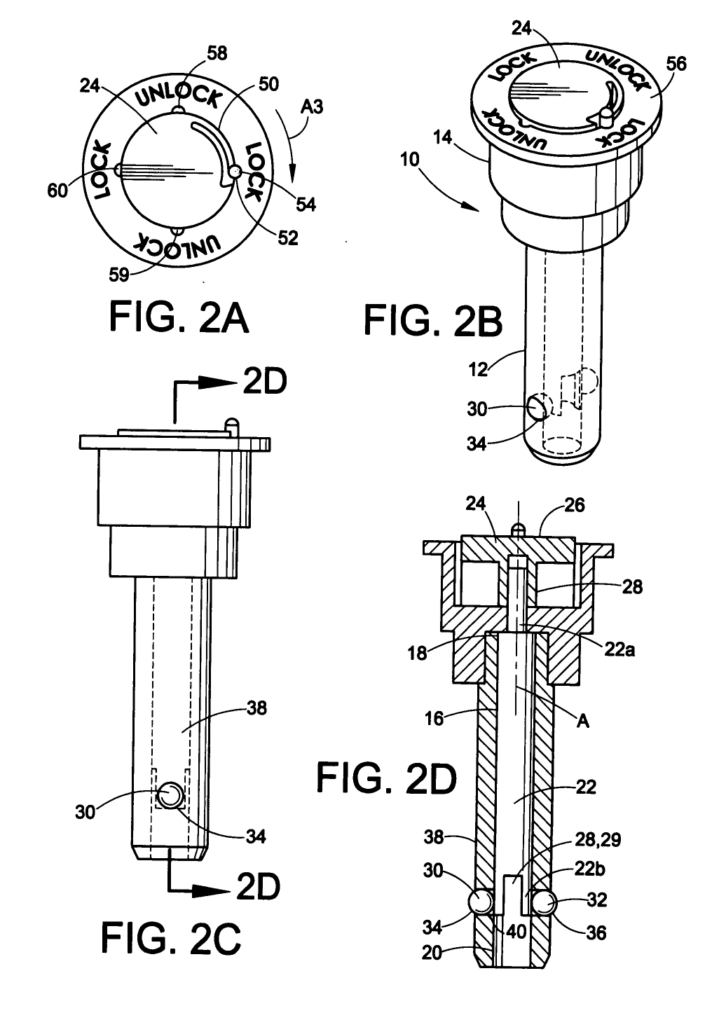

Referring now to the drawings, in particular referring to FIGS. 2A-2D, a quick release pin assembly 10 in accordance with an embodiment of the invention is shown that includes a shank 12 and a handle 14 attached to an upper portion of the shank. The shank has a central axial bore 16 having a first and a second end 18 and 20, respectively. Pin 10 further includes a shaft 22 that extends through bore 16 for rotational movement about axis A3. Shaft 22 has a first end and a second end 22a and 22b, respectively. The shank and shaft are preferably made from metal in each of the embodiments described herein.

Pin 10 further includes a knob 24 that can be configured in any one of a number of configurations, including any configuration known in the art, and/or other designs and configurations. Knob 24 has a thumb end 26, which is configured to be pressed by the end user thereby rotating knob 24 in direction A3, and a shaft end 28 that can be opposite to thumb end as is shown in these figures. The knob and handle are preferably fabricated from plastic or metal in each of the embodiments discussed herein.

Actuator button or knob 24 is fixed to the shaft 22 by any means known in the art. The handle 14 is secured to the shank 12 by any convenient means such as, for example by press fitting, brazing, swaging or screw threading. In the particular connection illustrated in the drawings, the shank and handle are connected by means of a threaded fit along inner surfaces of the shank and handle.

Shaft end 28 of knob 24 is configured to interengage with shaft 22 at first end 22a. First end 22a of the shaft has a smaller diameter than the second end 22b. The shaft can be joined to knob 24 by any means known in the art including, but not limited to, press fitting, brazing, swaging, screw threading and/or crimping the knob to the shaft. As a result, rotational movement of the knob is translated to the shaft.

Shaft end 22b has a pair of recessed openings or notches 28, 29 which serves to hold a pair of radially movable balls 30, 32 in their fully retracted position. The balls are preferably made of metal in each embodiment described herein. The recessed openings are shown as rectangular in shape, but they can be of other configurations as well without departing from the scope of the invention. In a fully projected position, the balls move radially outwardly into lateral bores or openings 34, 36, respectively, in an outer wall 38 of shank 12, as shown in FIGS. 2B-2D. The outer ends of the bores can be “staked” to reduce the size of the openings which intersect outer cylindrical surface 38 of the shank, and this reduced size opening retains each ball from laterally escaping. Rotational movement of shaft 22 brings surface 40 of the shaft out of alignment with the balls, such that the balls move into recesses 28, 29 thereby allowing balls 30, 32 to move radially inwardly so that they fall into openings 34, 36 such that they no longer extend beyond the outer surface 38 of the shank 12. Then, if the shaft is rotated 90 degrees (clockwise or counterclockwise), the balls are once again engaged by surface 40 which moves them radially outwardly such that they again move outwardly beyond surface 38 of shank 12.

In one embodiment, shown in FIGS. 2A-2D, rotational movement in direction A3 is by the force or thumb pressure exerted by the end user on knob 24. The user presses or moves the resiliently biased arm 50 of knob 24 radially inwardly so that pin 52 on an end of arm 50 is released from locked engagement with LOCK notch or opening 54 of upper end 56 of handle 14. Then, the knob is rotated 90 degrees either clockwise or counterclockwise until the pin 52 is aligned with one of the UNLOCK openings 58, 59. Then, the user releases the arm, and the arm snaps into one of openings 58, 59 in the unlocked position. When the knob is being rotated 90 degrees, the balls move radially inwardly into recesses or slots 28, 29 of the shaft 22.

To place the pin back into a locked position, the user again moves pin 52 radially inwardly to release the pin from engaging UNLOCK opening 58 or 59. Then, the knob is rotated clockwise or counterclockwise 90 degrees until the pin 52 is aligned with one of LOCK openings 54 or 60. Then, the pin is released and snapped into engagement with one of openings 54 or 60. The balls are pushed radially outwardly by outer surface 40 of shaft 22 until they move into openings 34, 36 of shank 12 and protrude beyond outer surface 38 of shank 12.

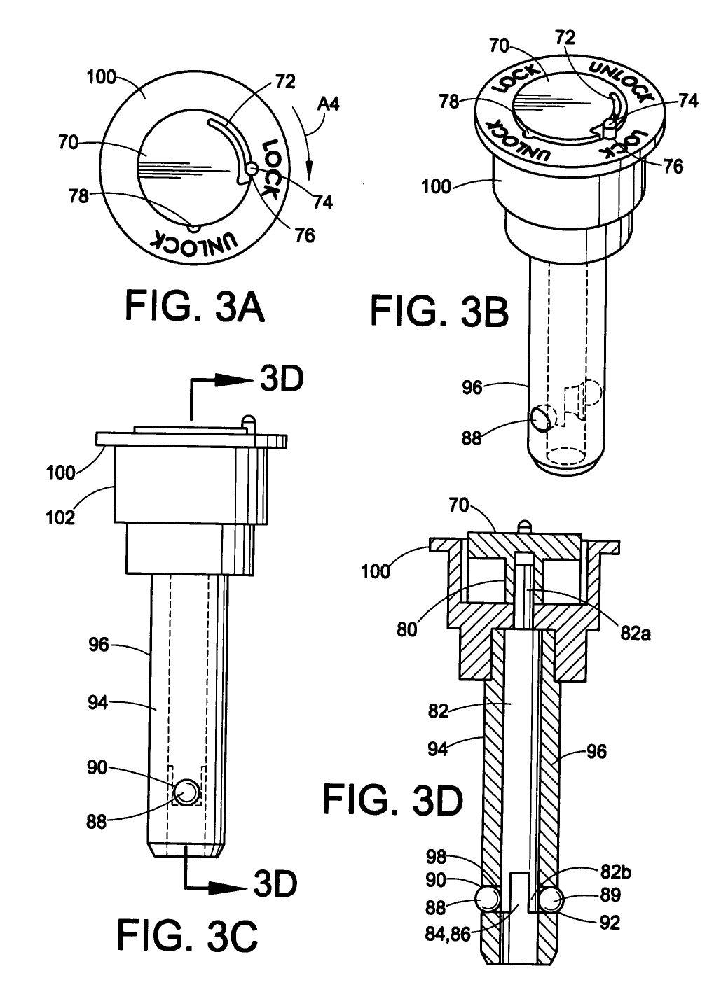

In accordance with another embodiment of the invention, referring to FIGS. 3A-3D, rotational movement of knob 70 is by a force or thumb pressure exerted by the user on knob 70. The user presses or moves the resiliently biased arm 72 of knob 70 radially inwardly so that pin 74 on an end of arm 72 is released from locked engagement with LOCK opening or slot 76. The knob is then rotated 90 degrees clockwise to an UNLOCK opening or slot 78. Then, the user releases the pin 74 to engage and lock into UNLOCK opening 78.

Shaft end 80 of knob 70 is configured to interengage with shaft 82 at first end 82a. First end 82a of the shaft has a smaller diameter than a second end 82b. The shaft can be joined to knob 70 by any means known in the art including, but not limited to, press fitting, brazing, swaging, screw threading and/or crimping the knob to the shaft. As a result, rotational movement of the knob is translated to the shaft.

Shaft end 82b has a pair of recessed openings or notches 84, 86 which serves to hold a pair of radially movable balls 88, 89 in their fully retracted position. The recessed openings are shown as rectangular in shape, but they can be of other configurations as well without departing from the scope of the invention. In a fully projected position, the balls move radially outwardly into lateral bores or openings 90, 92, respectively, in an outer wall 94 of shank 96, as shown in FIGS. 3B-3D. The outer ends of the bores can be “staked” to reduce the size of the openings which intersect outer cylindrical surface 94 of the shank, and this reduced size opening retains each ball from laterally escaping. Rotational movement of shaft 82 brings surface 98 of the shaft out of alignment with the balls, such that the balls move into recesses 84, 86 thereby allowing balls 88, 89 to move radially inwardly so that they fall into openings 90, 92 such that they no longer extend beyond the outer surface 94 of the shank 96. Then, if the shaft is rotated 90 degrees, the balls are once again engaged by surface 98 which moves them radially outwardly such that they again move outwardly beyond surface 94.

Rotational movement in direction A4 is by the force or thumb pressure exerted by the end user on knob 70. The user presses or moves the resiliently biased arm 72 of knob 70 radially inwardly so that pin 74 on an end of arm 72 is released from locked engagement with LOCK opening 76 of upper end 100 of handle 102. Then, the knob is rotated 90 degrees either clockwise or counterclockwise until the pin 74 is aligned with the UNLOCK opening 78. Then, the user releases the arm, and the arm snaps into opening 78 in the unlocked position. When the knob is being rotated 90 degrees, the balls move radially inwardly into recesses or slots 84, 86 of the shaft 82.

To place the pin back into a locked position, the user again moves pin 74 radially inwardly to release the pin from engaging opening 78. Then, the knob is rotated counterclockwise 90 degrees until the pin 74 is aligned with LOCK opening 76. Then, the pin is released and snapped into engagement with opening 76. The balls are pushed radially outwardly by outer surface 98 of shaft 82 until they move into openings 90, 92 of shank 96 and protrude beyond outer surface 94.

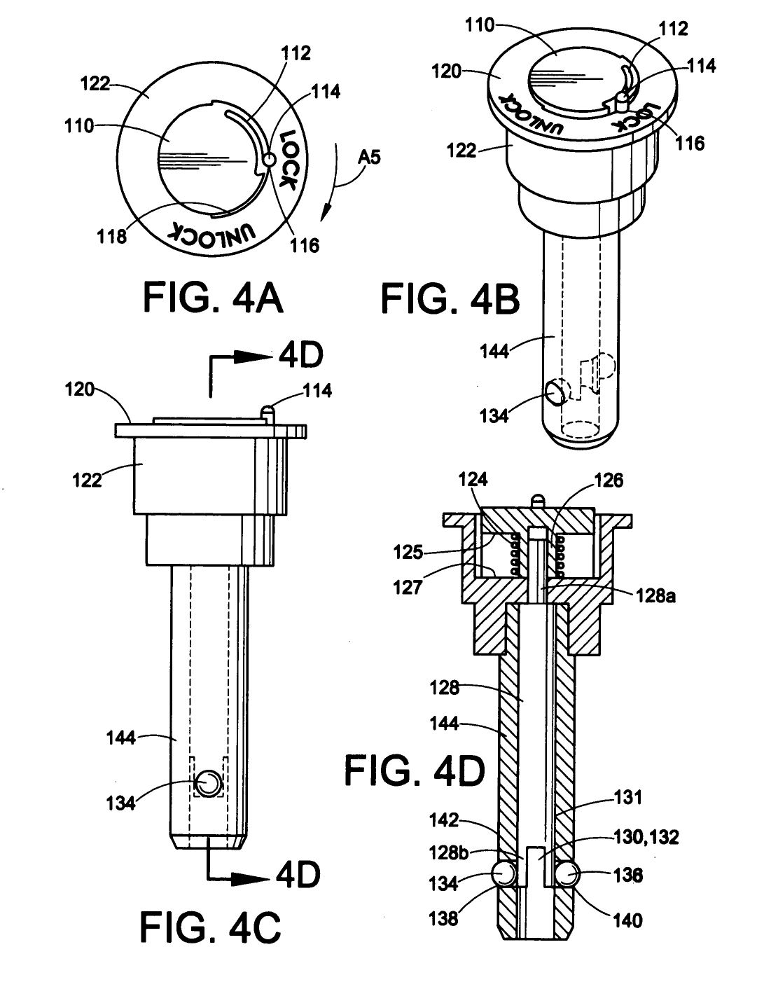

In accordance with another embodiment of the invention, referring to FIGS. 4A-4D, rotational movement of knob 110 is by a thumb pressure or force exerted by a user on knob 110. The user presses or moves the resiliently biased arm 112 of knob 110 radially inwardly and then a pin 114 on an end of arm 112 is released from locked engagement with LOCK opening 116. The user then rotates the knob 90 degrees clockwise until the pin 110 is aligned with the end of groove 118 formed in upper surface 120 of handle 122 adjacent the label “UNLOCK”. A coiled spring 124 positioned underneath the knob between a surface 125 of the knob and an inner surface 127 of the handle biases the knob to the locked position. As the knob is rotated to the UNLOCK position, the spring is rotated and is pulled or extended. Then, when the user releases the knob, the spring is released and biases the knob back to the LOCK opening 116.

Shaft end 126 of knob 110 is configured to interengage with shaft 128 at first end 128a. First end 128a of the shaft has a smaller diameter than a second end 128b. The shaft can be joined to knob 110 by any means known in the art including, but not limited to, press fitting, brazing, swaging, screw threading and/or crimping the knob to the shaft. As a result, rotational movement of the knob is translated to the shaft.

Shaft end 128b has a pair of recessed openings or notches 130, 132 which serves to hold a pair of radially movable balls 134, 136 in their fully retracted position. The recessed openings are shown as rectangular in shape, but they can be of other configurations as well without departing from the scope of the invention. In a fully projected position, the balls move radially outwardly into lateral bores or openings 138, 140, respectively, in an outer wall 142 of shank 144, as shown in FIGS. 4B-4D. The outer ends of the bores can be “staked” to reduce the size of the openings which intersect outer cylindrical surface 142 of the shank, and this reduced size opening retains each ball from laterally escaping. Rotational movement of shaft 128 brings surface 131 of the shaft out of alignment with the balls, such that the balls move into recesses 130,132 thereby allowing balls 134, 136 to move radially inwardly so that they fall into openings 138, 140 such that they no longer extend beyond the outer surface 142 of the shank. Then, if the shaft is rotated 90 degrees, the balls are once again engaged by surface 131 which moves them radially outwardly such that they again move outwardly beyond surface 142.

Rotational movement in direction A5 is by the force or thumb pressure exerted by the end user on knob 110. The user presses or moves the resiliently biased arm 112 of knob 110 radially inwardly so that pin 114 on an end of arm 112 is released from locked engagement with LOCK opening 116 of upper end 120 of handle 122. Then, the knob is rotated 90 degrees clockwise until the pin 114 is aligned with UNLOCK marking adjacent the end of groove 118. Then, the user has to hold the arm in the unlocked position. When the knob is being rotated 90 degrees, the balls move radially inwardly into recesses or slots 130, 132 of the shaft 128.

To place the pin back into a locked position, the user releases pin 114. Then, the knob rotates counterclockwise 90 degrees until the pin 114 is aligned with LOCK opening 116. Then, the pin is released and snapped into engagement with opening 116. The balls are pushed radially outwardly by outer surface 131 of shaft 128 until they move into openings 138, 140 of shank 144 and protrude beyond outer surface 142.

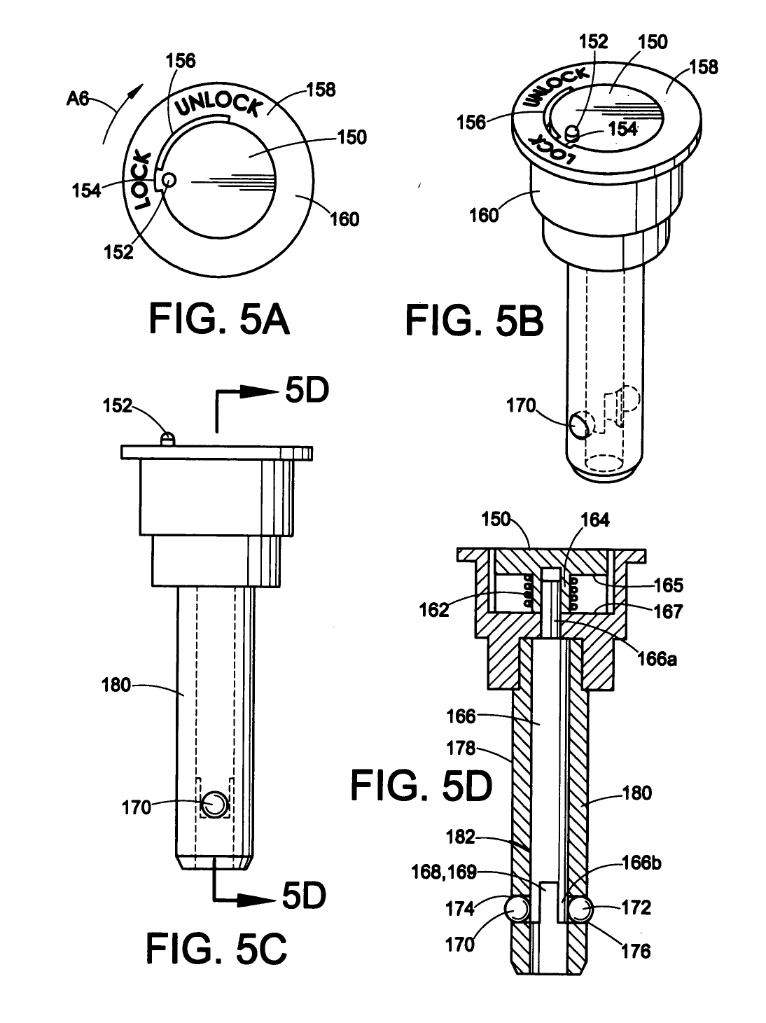

In accordance with another embodiment of the invention, referring to FIGS. 5A-5D, rotational movement of knob 150 is by a force or thumb pressure exerted by a user on knob 150. The user rotates the knob by holding pin 152 and rotating the knob 90 degrees either clockwise or counterclockwise. The user rotates the knob 90 degrees counterclockwise until a tab 154 of the knob is aligned with an end of groove 156 formed in upper surface 158 of handle 160 adjacent the labels “UNLOCK” and “LOCK”. A coiled spring 162 is located underneath the knob between a surface 165 of the knob and an inner surface 167 of the handle and biases the knob to the locked position. As the knob is rotated to the UNLOCK position, the spring is rotated and is pulled or extended. Then, when the user releases the knob, the spring becomes released and biases the knob back to the LOCK position.

Shaft end 164 of knob 150 is configured to interengage with shaft 166 at first end 166a. First end 166a of the shaft has a smaller diameter than a second end 166b. The shaft can be joined to knob 150 by any means known in the art including, but not limited to, press fitting, brazing, swaging, screw threading and/or crimping the knob to the shaft. As a result, rotational movement of the knob is translated to the shaft.

Shaft end 166b has a pair of recessed openings or notches 168, 169 which serves to hold a pair of radially movable balls 170, 172 in their fully retracted position. The recessed openings are shown as rectangular in shape, but they can be of other configurations as well without departing from the scope of the invention. In a fully projected position, the balls move radially outwardly into lateral bores or openings 174, 176, respectively, in an outer wall 178 of shank 180, as shown in FIGS. 5B-5D. The outer ends of the bores can be “staked” to reduce the size of the openings which intersect outer cylindrical surface 178 of the shank, and this reduced size opening retains each ball from laterally escaping. Rotational movement of shaft 166 brings outer surface 182 of the shaft out of alignment with the balls, such that the balls move into recesses 168, 169 thereby allowing balls 170, 172 to move radially inwardly so that they fall into openings 174, 176 such that they no longer extend beyond the outer surface 178 of the shank. Then, if the shaft is rotated 90 degrees, the balls are once again engaged by surface 182 which moves them radially outwardly such that they again move outwardly beyond surface 178.

Rotational movement in direction A6 is by the thumb pressure or force exerted by the end user on knob 150. The user rotates the knob 150 by holding pin 152 and rotating the tab 90 degrees from the LOCK position to the UNLOCK position. The tab 154 is aligned with the UNLOCK marking at an edge of the groove 156. The user must continue to hold pin 152 to maintain the tab in the UNLOCK position. When the knob is being rotated 90 degrees, the balls move radially inwardly into recesses or slots 168, 169 of the shaft 166.

To place the pin back into a locked position, the user releases pin 152 which releases the spring 162 which causes the knob to rotate counterclockwise 90 degrees until the tab 154 is aligned with the LOCK position. Spring 162 biases the knob in the LOCK position. The balls are pushed radially outwardly by outer surface 182 of shaft 166 until they move into openings 174, 176 of shank 180 and protrude beyond outer surface 178.

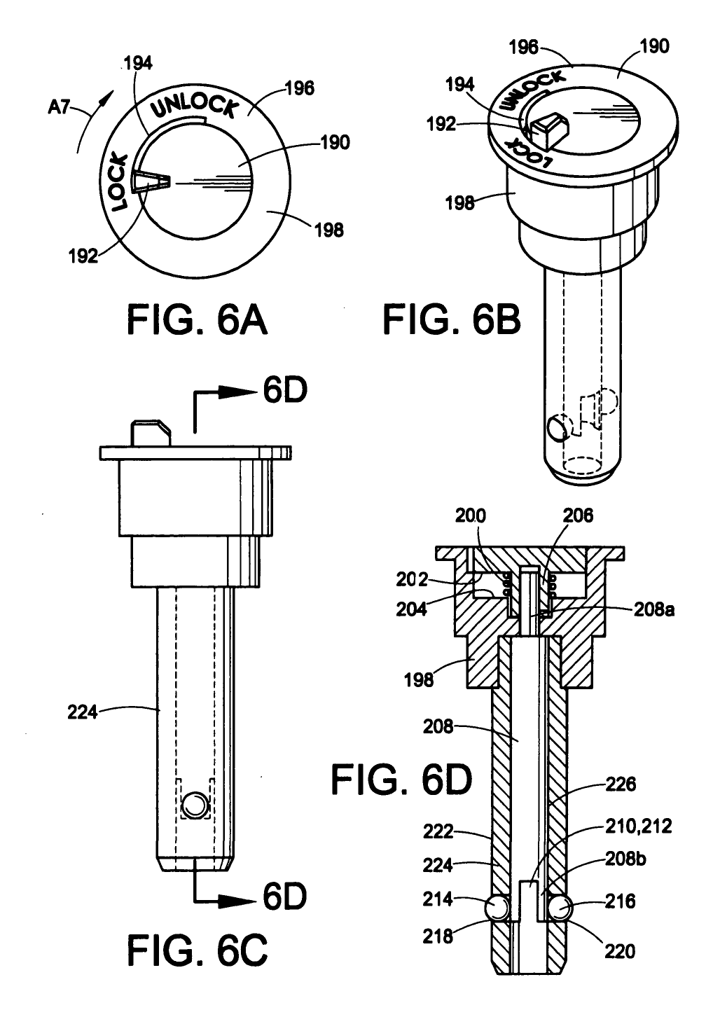

In accordance with another embodiment of the invention, referring to Figures 6A-6D, rotational movement of knob 190 is by a force or thumb pressure exerted by a user on knob 190. The user rotates the knob 90 degrees clockwise by holding a wedge shaped tab 192 between a LOCK position and one end of groove 194 formed in upper surface 196 of handle 198 and an UNLOCK position on an opposite edge of groove 194. The user rotates the knob 90 degrees clockwise until the tab 192 is aligned with the end of groove 194 adjacent the label “UNLOCK”. A coiled spring 200 underneath the knob between a surface 202 of the knob and an inner surface 204 of the handle biases the knob to the locked position. As the knob is rotated to the UNLOCK position, the spring is pulled and is extended. The user must hold the tab in the UNLOCK position. Then, when the user releases the knob, the spring becomes released and biases the knob back to the LOCK position.

Shaft end 206 of knob 190 is configured to interengage with shaft 208 at first end 208a. First end 208a of the shaft has a smaller diameter than a second end 208b. The shaft can be joined to knob 190 by any means known in the art including, but not limited to, press fitting, brazing, swaging, screw threading and/or crimping the knob to the shaft. As a result, rotational movement of the knob is translated to the shaft.

Shaft end 208b has a pair of recessed openings or notches 210, 212 which serves to hold a pair of radially movable balls 214, 216 in their fully retracted position. The recessed openings are shown as rectangular in shape, but they can be of other configurations as well without departing from the scope of the invention. In a fully projected position, the balls move radially outwardly into lateral bores or openings 218, 220, respectively, in an outer wall 222 of shank 224, as shown in FIGS. 6B-6D. The outer ends of the bores can be “staked” to reduce the size of the openings which intersect outer cylindrical surface 222 of the shank, and this reduced size opening retains each ball from laterally escaping. Rotational movement of shaft 208 brings outer surface 226 of the shaft out of alignment with the balls, such that the balls move into recesses 210, 212 thereby allowing balls 214, 216 to move radially inwardly so that they fall into openings 218, 220 such that they no longer extend beyond the outer surface 222 of the shank. Then, if the shaft is rotated 90 degrees, the balls are once again engaged by surface 226 which moves them radially outwardly such that they again move outwardly beyond surface 222.

Rotational movement in direction A7 is by the force or thumb pressure exerted by the end user on knob 190. The user rotates knob 90 degrees clockwise so that tab 192 is aligned with the UNLOCK position on groove 194. When the knob is being rotated 90 degrees, the balls move radially inwardly into recesses or slots 210, 22 of the shaft.

To place the tab back into a locked position, the user releases the tab 192. Then, the spring 200 is released and the knob is rotated counterclockwise 90 degrees until the tab 192 is aligned with LOCK position of groove 194. The balls are pushed radially outwardly by outer surface 226 of the shaft until they move into openings 218, 220 of the shank and protrude beyond outer surface 222.

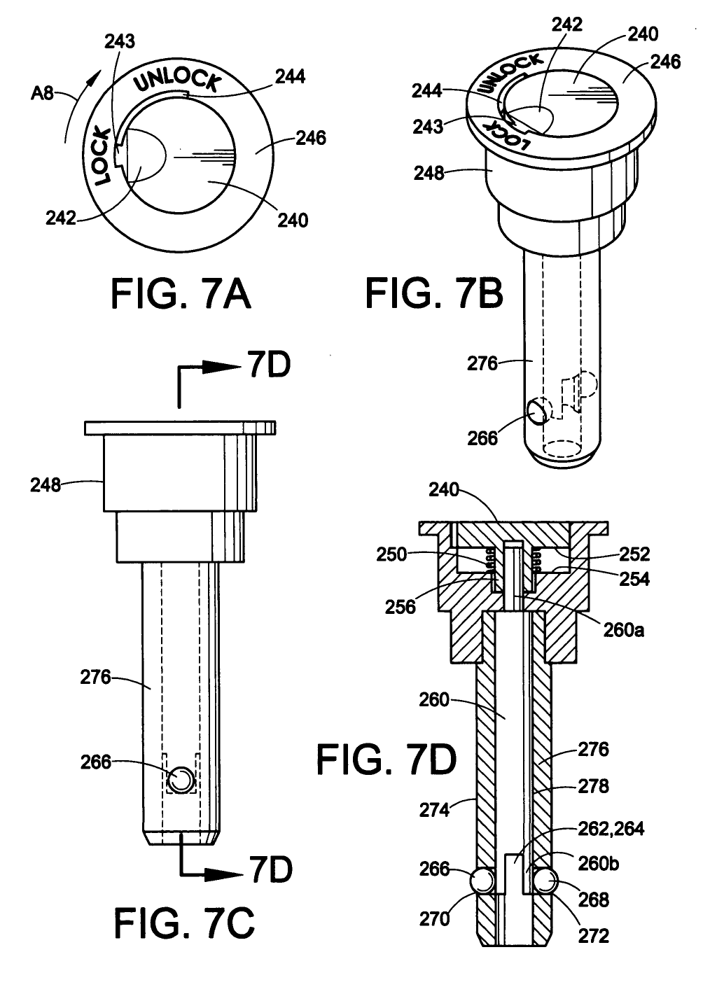

In accordance with another embodiment of the invention, referring to FIGS. 7A-7D, rotational movement of knob 240 is by a thumb pressure or force exerted by a user on knob 240. The user uses a finger or thumb to press knob 240 within a thumb dimple or indentation 242 to rotate the knob 240 clockwise until the knob is aligned with an end of groove 244 formed in upper surface 246 of handle 248 adjacent the label “UNLOCK”. A coiled spring 250 is positioned underneath the knob between a surface 252 of the knob and an inner surface 254 of handle 248 and biases the knob to the locked position. As the knob is rotated to the UNLOCK position, the spring is pulled and extended. Then, when the user releases the knob, the spring becomes released and biases the knob back to the LOCK position.

Shaft end 256 of knob 240 is configured to interengage with shaft 260 at first end 260a. First end 260a of the shaft has a smaller diameter than a second end 260b. The shaft can be joined to knob 240 by any means known in the art including, but not limited to, press fitting, brazing, swaging, screw threading and/or crimping the knob to the shaft. As a result, rotational movement of the knob is translated to the shaft.

Shaft end 260b has a pair of recessed openings or notches 262, 264 which serves to hold a pair of radially movable balls 266, 268 in their fully retracted position. The recessed openings are shown as rectangular in shape, but they can be of other configurations as well without departing from the scope of the invention. In a fully projected position, the balls move radially outwardly into lateral bores or openings 270, 272, respectively, in an outer wall 274 of shank 276, as shown in FIGS. 7B-7D. The outer ends of the bores can be “staked” to reduce the size of the openings which intersect outer cylindrical surface 274 of the shank, and this reduced size opening retains each ball from laterally escaping. Rotational movement of the shaft brings surface 278 of the shaft out of alignment with the balls, such that the balls move into recesses 262, 264 thereby allowing balls 266, 268 to move radially inwardly so that they fall into openings 270, 272 such that they no longer extend beyond the outer surface 274 of the shank. Then, if the shaft is rotated 90 degrees, the balls are once again engaged by surface 278 which moves them radially outwardly such that they again move outwardly beyond surface 274.

Rotational movement in direction A8 is by the thumb pressure exerted by the end user on knob 240. The user presses and rotates the knob 90 degrees clockwise until the knob is aligned with the UNLOCK position or groove 244. The user continues to press on the indentation 242 to hold the knob in the UNLOCK position. When the knob is being rotated 90 degrees, the balls move radially inwardly into recesses or slots 262, 264 of the shaft.

To place the pin back into a locked position, the user releases the knob which releases spring 250 which rotates the knob counterclockwise 90 degrees until knob 240 is aligned with LOCK position. The balls are pushed radially outwardly by outer surface 278 of the shaft until they move into openings 270, 272 of the shank and protrude beyond outer surface 274.

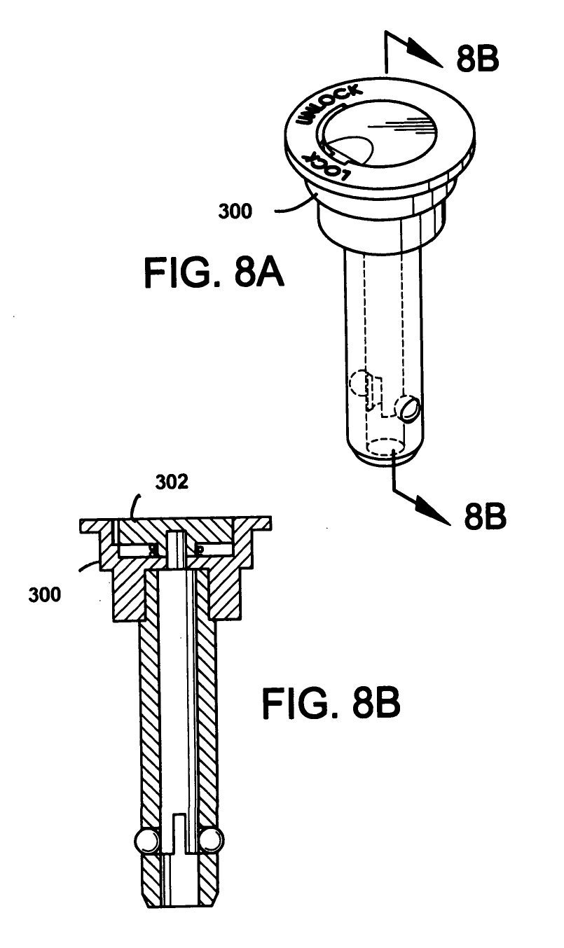

Referring to FIGS. 8A and 8B, the pin of FIGS. 7A-7D is shown with a lower profile handle 300. Knob 302 has a lower profile as well. Other features of the pin arrangement are essentially as described for FIGS. 7A-7D.

While considerable emphasis has been placed on the preferred embodiments of the invention illustrated and described herein, it will be appreciated that other embodiments and/or equivalents thereof can be made, and that many changes can be made in the preferred embodiments without departing from the principles of the invention. Accordingly, it is to be distinctly understood that the foregoing descriptive matter is to be interpreted merely as illustrative of the invention and not as a limitation.

1. A quick release pin comprising:
an elongated body having an axial bore therethrough;
a shaft extending at least partially through said axial bore for rotational movement within said bore;
a button mounted on a first end of said shaft;
at least one opening formed in a second end of said shaft;
a handle having a central passage through which said button extends, wherein said handle is mounted to said elongated body; and
wherein said button comprises a resilient member for engaging and disengaging an opening in said handle for locking and unlocking said pin.

2. The pin of claim 1, further comprising a spring positioned between said button and said handle which engages said button to bias said button in a locked position.

3. The pin of claim 1, wherein said button is fixedly secured to said shaft.

4. The pin of claim 1, wherein said resilient member of said button further comprises a tab on an end of said resilient member.

5. The pin of claim 1, wherein said handle comprises at least two openings on an upper surface of said handle, wherein one of said openings engages the resilient member to lock the pin in a locked position and another of said openings engages the resilient member to lock the pin in an unlocked position.

6. The pin of claim 5, wherein said button is rotated 90 degrees between said locked position and said unlocked position.

7. The pin of claim 1, further comprising a pair of movable members which are received within at least one opening in said second end of said shaft.

8. The pin of claim 7, wherein said movable members are received by openings formed in an outer surface of said elongated body.

9. The pin of claim 8, wherein rotation of said shaft 90 degrees moves said movable members between an extended position within said openings in said elongated body and a retracted position within said at least one opening in said second end of said shaft.

10. The pin of claim 9, wherein rotational movement of said shaft brings an outer surface of said shaft out of alignment with said movable members so said movable members move radially inwardly into said at least one opening of said shaft.

11. The pin of claim 10, wherein rotational movement of said shaft brings said outer surface of said shaft into alignment with said movable members so said movable members engage said outer surface of said shaft moving said movable members radially outwardly into said openings of said elongated body beyond an outer surface of said elongated body.

12. The pin of claim 1, wherein said shaft first end has a diameter smaller than said shaft second end.

13. The pin of claim 1, wherein said handle further comprises a groove formed in an upper surface thereof.

14. The pin of claim 13, wherein said resilient member is moved out of engagement with said opening of said handle and slides along said groove when said button is rotated.

15. The pin of claim 14, further comprising a coiled spring mounted between said button and said handle for biasing said button to a locked position.

16. The pin of claim 15, wherein said button is rotated 90 degrees between a locked position and an unlocked position.

17. The pin of claim 16, wherein said resilient member of said button slides along said groove to an unlocked position at an edge of said groove.

18. A release pin, comprising:
an elongated body having an axial bore therethrough;
a shaft extending through said bore for rotational movement;
a knob mounted to a first end of said shaft;
at least one slot formed in a second end of said shaft;
a handle mounted to said elongated body, said handle having a central passage therethrough;
a biasing member interposed between said knob and said handle within said central passage for biasing said knob in a locked position;
wherein said knob comprises a member which engages and slides along a groove formed in a surface of said handle.

19. The pin of claim 18, wherein said member of said knob comprises a tab extending from said knob.

20. The pin of claim 18, wherein said knob is rotated 90 degrees between a locked position and an unlocked position.

21. The pin of claim 20, wherein one edge of said groove corresponds to the locked position and a second edge of said groove corresponds to an unlocked position.

22. The pin of claim 18, wherein said knob further comprises a pin for rotating said knob.

23. The pin of claim 19, wherein said tab is wedge shaped.

24. The pin of claim 18, wherein said knob further comprises an indentation for pressing said knob.

25. The pin of claim 18, wherein said knob is fixedly secured to said shaft.

26. The pin of claim 18, further comprising a pair of movable members which are received within at least one slot in said second end of said shaft.

27. The pin of claim 26, wherein said movable members are received by openings formed in an outer surface of said elongated body.

28. The pin of claim 27, wherein rotation of said shaft 90 degrees moves said movable members between an extended position within said openings in said elongated body and a retracted position within said at least one slot in said second end of said shaft.

29. The pin of claim 29, wherein rotational movement of said shaft brings an outer surface of said shaft out of alignment with said movable members so said movable members move radially inwardly into said at least one slot of said shaft.

30. The pin of claim 30, wherein rotational movement of said shaft brings said outer surface of said shaft into alignment with said movable members so said movable members engage said outer surface of said shaft moving said movable members radially outwardly into said openings of said elongated body beyond an outer surface of said elongated body.

31. The pin of claim 18, wherein said shaft first end has a diameter smaller than said shaft second end.
